(19) United States
(12) Patent Application Publication
(10) Pub. No.: US 2008/0293010 A1
(43) Pub. Date: Nov. 27, 2008

(54) Implant drill

(76) Inventor: Young Wan Song, Seoul (KR)

Correspondence Address: BACON & THOMAS, PLLC, 625 SLATERS LANE, FOURTH FLOOR, ALEXANDRIA, VA, 22314-1176, US

(21) Appl. No.: 12/153,292

(22) Filed: May 16, 2008

Related U.S. Application Data
(63) Continuation-in-part of application No. PCT/KR2007/000486, filed on Jan. 26, 2007.

(30) Foreign Application Priority Data
Feb. 17, 2006 (KR) 10-2006-0015531
Feb. 17, 2006 (KR) 10-2006-0015535
Feb. 23, 2006 (KR) 10-2006-0017662

(51) Int. Cl. A61C 3/02

(52) U.S. Cl. 433/165

(57) ABSTRACT

There is provided an implant drill for maxillary sinus lifting, which is capable of easily and simply boring the maxillary bone, without damaging the lining membrane of the maxillary sinus, to easily operate the maxillary sinus lifting and to expand a boring part of the maxillary born for implant placement. The implant drill for maxillary sinus lifting, which includes a central shaft with a shank in a body to be mounted onto a general dental hand piece, comprises a protrusion member elastically positioned in the body so as to move forward and backward or a lifting member being free from the rotation of the body.

The present application is a Continuation In Part application of the PCT/KR2007/000486 (WO 2007/094574 A1) filed 26 Jan. 2007.

### TECHNICAL FIELD

The present invention relates to a dental implant drill, and more particularly, to an implant drill for maxillary sinus lifting, which is capable of easily and simply boring the maxillary bone, without damaging the lining membrane of the maxillary sinus, to easily operate the maxillary sinus lifting and to expand a boring part of the maxillary bone for implant placement.

### BACKGROUND ART

Today, the implant operation for placing an artificial tooth has been rapidly spread.

However, quite a number of patients have the mouth structures with difficult in performing the implant operation. Some dentists are reluctant to perform the implant operation in these patients.

Specifically, when a remaining bone in a posterior region where the maxillary sinus is positioned is insufficient, it is very hard to place an implant. In this case, after a space is secured by lifting the lining membrane of the maxillary sinus, a bone is transplanted in the secured space and then an implant is placed to be embedded therein. This method of placing an implant is divided into two manners, such as a vertical approach manner and a side approach manner.

The vertical approach manner is used when the remaining bone is certainly secured in a part for the implant operation (that is, when the thickness of the remaining bone is 4 mm or above). In this case, a device, such as an osteotome (a chisel and a mallet), is used to tap the maxillary bone several times, and bore an aperture being 2 to 3 mm in diameter into the maxillary bone, without damaging the lining membrane of the maxillary sinus, and a transplant bone is little by little inserted into the aperture.

In this vertical approach manner, since the surgical operation part is narrow, the part less swells after the operation. However, since it is impossible to directly see the lining membrane of the maxillary sinus during the surgical operation, a dentist needs to very carefully perform the operation while checking an operation process by X-rays. Therefore, a long time is required for the surgical operation. Moreover, a shock during the operation process may cause a very unpleasant feeling to a patient.

The side approach manner is used when the remaining bone is very insufficient in the part for the implant operation (that is, when the thickness of the remaining bone is 4 mm or below). In this case, an aperture (window) is formed on the side of the maxillary sinus and the lining membrane of the maxillary sinus is lifted to transplant a bone.

In the side approach manner, since a dentist lifts the lining membrane of the maxillary sinus while directly seeing it during the surgical operation, the lining membrane of the maxillary sinus is less damaged. Even if the lining membrane of the maxillary sinus is damaged, a post-treatment is possible. Further, since a bone transplant material in a desired amount can be promptly inserted at once, the progress thereof is fast.

However, the surgical operation is difficult and a valve needs to be formed.

Therefore, after the surgical operation, a patient has a severe edema. Due to these reasons, the side approach manner is in fact avoided.

Meantime, research has been conducted for a maxillary sinus lifting technique using a general implant drill and a trephine drill shown in FIGS. 1 and 2, together with the above-mentioned methods.

A patient has less aversion to the surgical operation using the implant drill. Further, the maxillary bone can be easily and fast bored. However, when the boring of the maxillary bone is completed by the rotation of a drill bit, since no means is prepared to prevent a tip of the drill bit from contacting with the lining membrane of the maxillary sinus, the lining membrane of maxillary sinus may be damaged by being torn or rolled by the tip of the drill bit. Therefore, it can be said that the maxillary sinus lifting technique using a drill is almost impossible at present.

### DISCLOSURE OF INVENTION

### Technical Problem

Therefore, the present invention is directed to provide an implant drill for maxillary sinus lifting, which is capable of easily and simply boring the maxillary bone, without damaging the lining membrane of the maxillary sinus, to easily operate the maxillary sinus lifting.

Another object of the present invention is to provide an implant drill for maxillary sinus lifting, which is capable of easily and simply expanding a boring part of the maxillary bone for implant placement, without damaging the lining membrane of the maxillary sinus.

### Technical Solution

In accordance with an exemplary embodiment, the present invention provides an implant drill for maxillary sinus lifting, which includes a cylindrical drill bit, and a central shaft which is mounted onto a general dental hand piece, comprising: a through-aperture formed at the center part of the cylindrical drill bit in a vertical direction and a lifter equipped in the through-aperture.

Then, the lifter may be a protrusion member equipped in the through-aperture of the drill bit freely from the rotation of the drill or a fluid pressure apparatus including hydraulic lifter.

Further, the protrusion member may include a spring or a magnets or a fluid pressure apparatus as a pusher so that the pusher pushes the protrusion member is pushed out.

Then, the front end of the protrusion rod may be processed to be round, and the lifting member may have a shape being wide at both end parts and narrow in a middle part so that the middle part is hinge-coupled at an end of the drill, and the lifting member with a first end positioned outside the drill and a second end positioned inside the drill may be free from the rotation of the drill.

Further, the second end of the lifting member, positioned inside the drill, may have a conical shape, and the apex part of the second end may be supported inside the drill.

Further, the present invention provides a drill wherein the cylinder comprises an opening to wash the through-aperture of the cylinder and the more, the inner part of the protrusion member, the head of the protrusion member, has a marker to see the marker through the opening in order to see whether the first end of the protrusion member is out or not.

Further, the present invention provides a drill wherein the cylinder is divided into two pieces and the pieces are coupled with a coupling.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 is a front view of a conventional dental drill;

FIG. 2 is a perspective view of a conventional trephine drill;

FIG. 3 is a sectional view of an implant drill for maxillary sinus lifting according to an exemplary embodiment of the present invention;

FIGS. 4 to 7 are sectional views of the implant drills for maxillary sinus lifting according to another exemplary embodiments of the present invention;

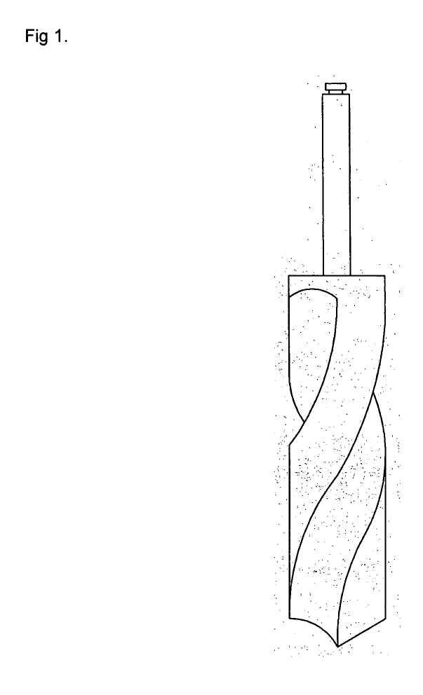

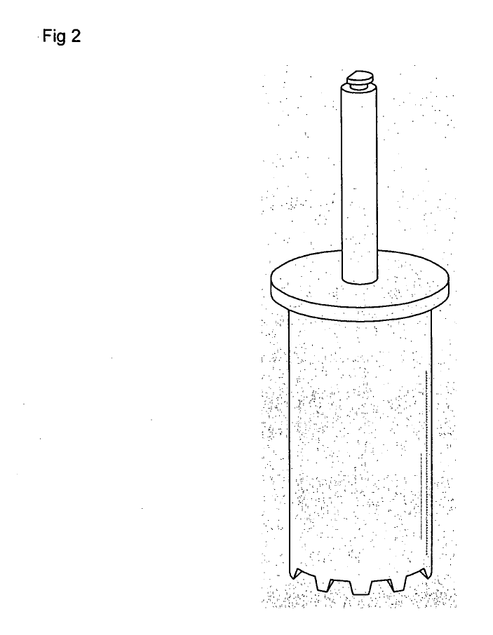

### MODE FOR THE INVENTION

The present invention will now be described more fully hereinafter with reference to the accompanying drawings, in which preferred exemplary embodiments of the invention are shown.

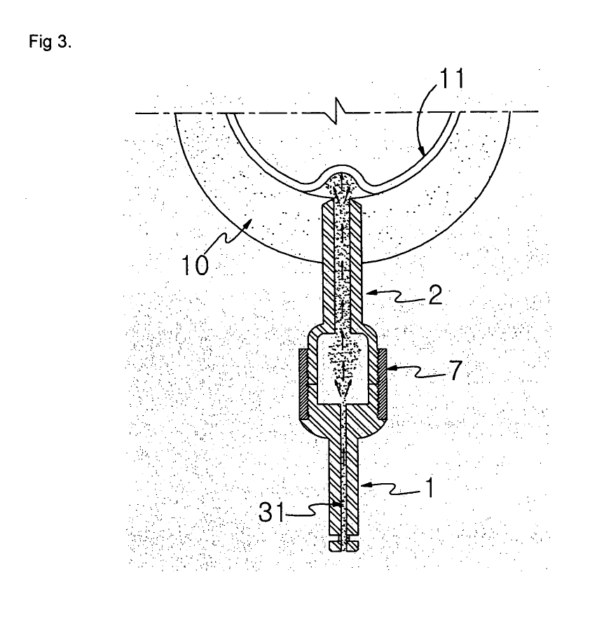

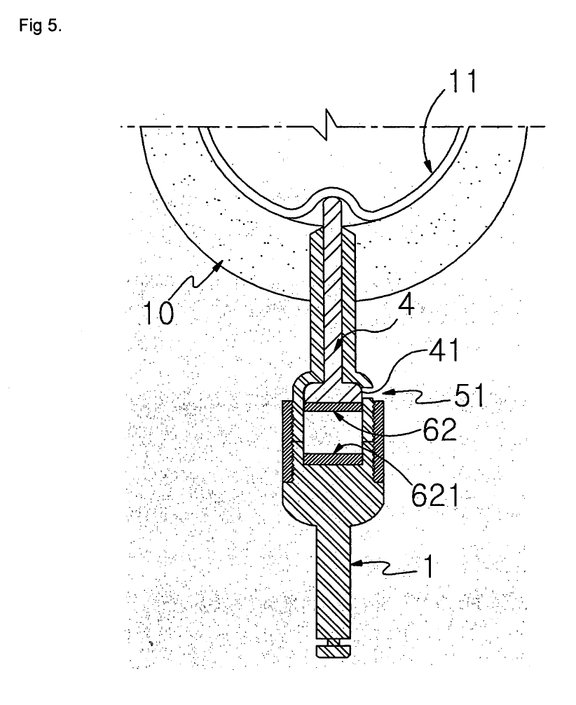

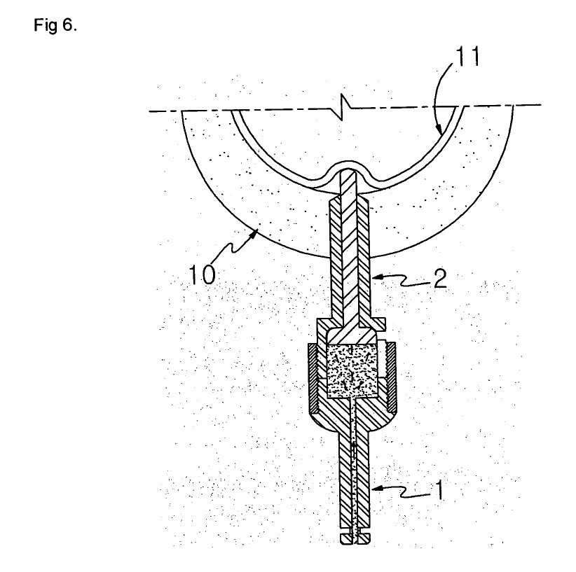

FIGS. 3 through 7 are views for explaining an implant drill for maxillary sinus lifting according to an exemplary embodiment of the present invention.

As illustrated in FIG. 3, the implant drill comprises a connector 1 and a drill bit 2 wherein a through-aperture 3 formed at the center part of the drill bit 2 in a vertical direction and a lifter is equipped in the through-aperture.

The connector 1 is mounted onto a general dental hand piece (not shown in the figure).

As shown in the FIG. 3, it is prefer that the lifter is a fluid pressure apparatus which let fluid flow out through the through-aperture. The fluid pressure apparatus includes a presser (not shown in the figure) and a path 31 to the through-aperture 3. The fluid pressure apparatus includes hydraulic lifter.

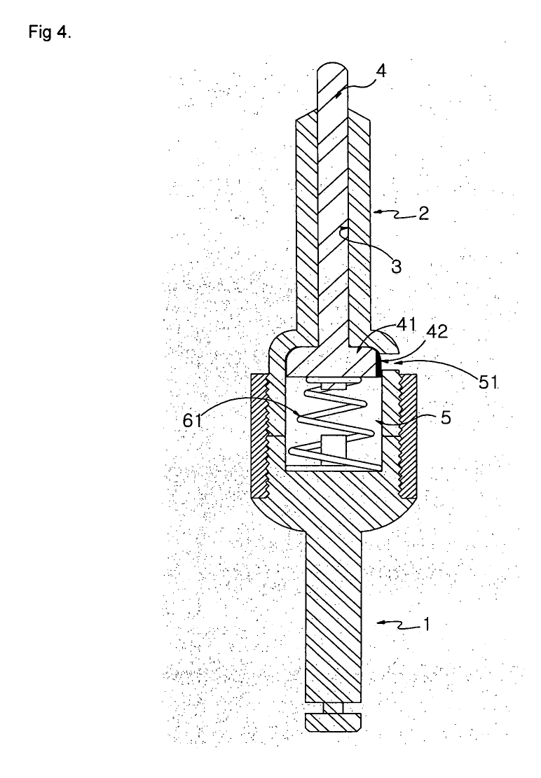

As shown in the FIG. 4, the lifter may be a protrusion member which includes a protrusion rod 4 equipped in the through-aperture 3 and a pushing member that pushes the protrusion rod 4 out. The protrusion rod 4 includes an inner head 41 which does not to allow the protrusion rod 4 to be separated from the drill bit 2. The pushing member includes a cylinder 5 formed between the connector 1 and the drill bit 2, and a pusher which pushes the protrusion rod 4 outward.

The pusher may be a spring 61, or magnets 62, 621 or fluid pressure apparatus.

The spring 61 is positioned between the inner head 41 of the protrusion rod 4 and the opposite inner wall of the cylinder 5 to push the protrusion rod 4 outward.

Two magnets 62, 621 are equipped to push each other by laying their poles to be accorded.

Fluid pressure apparatus for pushing the protrusion rod 4 outward may be comprised by a compressor (not shown in the figures) and a path 31 to the protrusion rod 4 in which the fluid pressure is applied by the compressor.

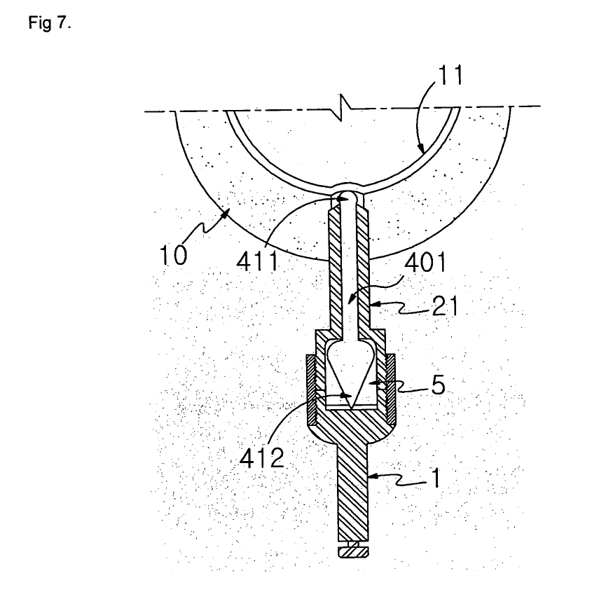

As shown in the FIG. 7, the protrusion rod 401 may has a shape being wide at both end parts and narrow in a middle part so that the middle part is hinge-coupled at an end of the drill bit 21, and the protrusion rod 401 with a first end 411 positioned outside the drill bit 21 and a second end 412 positioned inside the drill bit is free from the rotation of the drill bit 21 and the second end 412 of the protrusion rod 401, positioned inside the drill bit 21 has a conical shape, and the apex part of the second end 412 is supported inside the cylinder 5.

The present invention provides further an implant drill, wherein the cylinder 5 comprises an opening 51 on the side wall. Through the opening 5 the inner part of the cylinder 5 may be cleaned.

The inner head 41 of the protrusion rod 4 includes a marker 42 at it's periphery. The marker 42 may be a painting surface or a LED member. And, therefore, it is possible to recognize whether the protrusion rod 4 is protruded outward or not, by observing the marker 42.

The present invention provides further an implant drill, wherein the cylinder 5 is divided into two pieces and the pieces are coupled with a coupling.

The two bodies may be combined with each other by using a screw 7 as a coupling or by welding if a connecting force is secured at a predetermined level.

The connector 1 and the cylinder 5 may be a single body or two separated bodies and in this case the separated bodies should be coupled with coupling means. And also, the cylinder 5 and the drill bit 2 may be a single body or two separated bodies and in this case the separated body should be coupled with coupling means.

A process of boring the maxillary bone, using the implant drill according to the exemplary embodiment of the present invention as shown in the FIG. 3 will be described in detail.

The connector 1 is mounted onto a dental hand piece driving part, so that the entire implant drill is rotated when power is applied. As illustrated in FIG. 4, the drill bit 2 is allowed to approach to a part for surgical operation.

After a dentist applies a force so that the drill bit 2 is secured against to the part for the surgical operation, the power is applied to the hand piece to rotate the drill bit 2.

Then, as illustrated in FIG. 3, During the operation the fluid pressure is applied to the exit of the through-aperture 3 of the drill bit 2.

When the boring of the maxillary bone 10 is completed and the drill bit 2 reaches the lining membrane 11 of the maxillary sinus in a state surrounding an empty space, the fluid pressure lifts the lining membrane 11 of the maxillary sinus towards the empty space. And therefore the lining membrane 11 is prevented from being damaged by the drill bit 2. This easily secures a space for inserting a bone transplant material.

Another embodiment of the present invention as shown in the FIG. 4 will be described in detail.

The connector 1 is mounted onto a dental hand piece driving part, so that the entire implant drill is rotated when power is applied. As illustrated in FIG. 4, the drill bit 2 is allowed to approach to a part for surgical operation.

After a dentist applies a force so that the drill bit 2 is secured against to the part for the surgical operation, the power is applied to the hand piece to rotate the drill bit 2.

Then, as illustrated in FIG. 4, 5, 6 since the spring 61 or magnets 62, 621 is/are positioned or fluid pressure is applied at the back of the protrusion rod 4, the protrusion rod 4 is pressed by contact with the maxillary bone 10 when the drill operates.

When the boring of the maxillary bone 10 is completed and the drill bit 2 reaches the lining membrane 11 of the maxillary sinus in a state surrounding an empty space, the pressure to the protrusion rod 4 by the maxillary bone 10 is momentarily released. Therefore, as illustrated in FIGS. 4, 5, 6 the protrusion rod 4 protrudes forwardly by the elasticity of the spring 61 or magnet 62, 621 or fluid pressure and lifts the lining membrane 11 of the maxillary sinus towards the empty space. And therefore the lining membrane 11 is prevented from being damaged by the drill bit 2. This easily secures a space for inserting a bone transplant material.

While the protrusion rod 4 protrudes from the inside of the through-aperture 3 of the drill bit 2 and contacts with the lining membrane 11 of the maxillary sinus, the front end of the protrusion rod 4 may damage the lining membrane 11 of the maxillary sinus. However, in accordance with the embodiment of the present invention, since the front end of the protrusion rod 4 is processed to be round, the lining membrane 11 of the maxillary sinus is prevented from being damaged by the front end of the protrusion rod 4.

A process of expanding an existing boring part of the maxillary bone 10, using the implant drill as shown in the FIG. 7 according to another exemplary embodiment of the present invention will be described in detail.

The connector 1 is mounted onto a dental hand piece driving part, so that the drill bit 21 is rotated when power is applied. As illustrated in FIG. 7, the first end 411 of the protrusion rod is allowed to approach a part for surgical operation.

After a dentist applies a force so that the drill bit 21 is secured against the part for the surgical operation, the power is applied to the hand piece to rotate the implant drill bit 21.

Then, as illustrated in FIG. 7, the first end of the drill bit 21 is positioned in front of the drill bit 21 when the drill bit 21 cuts the circumference of the boring part to be expanded.

Generally, since the diameter of the boring into the maxillary bone is about 3 mm, the tip of the drill bit 21 in the present invention is 3 mm to be same as the diameter of the boring into the maxillary bone. Since the body of the drill bit 21 needs to be capable of expanding the boring part, the diameter thereof is 3.8 mm to be greater than the diameter of the boring into the maxillary bone.

To expand the entire boring part in the maxillary bone, the body of the drill bit 21 is to completely perforate into the existing boring part. In accordance with the embodiment of the present invention, as illustrated in FIG. 7, since the first end 411 of the protrusion rod 401 is positioned at the tip of the drill bit 21, the first rod 411 precedes the drill bit 21 and lifts the lining membrane 11 of the maxillary sinus towards an empty space when contacting with the lining membrane 11 of the maxillary sinus. Therefore, even though the drill bit 21 completely perforates into the boring part, the lining membrane 11 of the maxillary sinus is prevented from being damaged.

When the first end 411 contacts with the lining membrane 11 of the maxillary sinus, the protrusion rod 401 is slightly pushed backward by the resistance of the lining membrane 11 of the maxillary sinus so that the apex part of the second end 412 comes into contact with the bottom surface of the cylinder 5.

However, since the contact area between the apex part of the first end 412 and the bottom surface of the cylinder 5 is very small, the protrusion rod 401 is supported irrespective of the rotation of the drill bit 21. Since the protrusion rod 401 dose not rotate by itself, the lining membrane 11 of the maxillary sinus is prevented from being damaged by the protrusion rod 401 in contact with the lining membrane 11 of the maxillary sinus.

The invention has been described using preferred exemplary embodiments.

However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents.

The scope of the claims, therefore, should be accorded the broadest interpretation so as to encompass all such modifications and similar arrangements.

### INDUSTRIAL APPLICABILITY

In the implant drill for the maxillary sinus lifting according to the embodiment of the present invention, when the drill bit completely perforates into the maxillary bone, the front end of the protrusion member moves forward to lift the lining membrane of the maxillary sinus. Accordingly, since the tip of the drill bit is basically prevented from approaching the lining membrane of the maxillary sinus. The maxillary sinus lifting is easily and simply performed without damaging the lining membrane of the maxillary sinus by the drill bit.

1. An implant drill for maxillary sinus lifting, which includes a drill bit and a central shaft formed on the drill bit which is mounted onto a general dental hand piece, comprising: a through-aperture formed at the center part of the drill bit in a vertical direction and a lifter equipped in the through-aperture of the drill bit.

2. The implant drill according to claim 1, wherein the lifter is a fluid pressure apparatus including hydraulic lifter.

3. The implant drill according to claim 1, wherein the lifter is a protrusion member equipped in the through-aperture of the drill bit freely from the rotation of the drill.

4. The implant drill according to claim 2, wherein the protrusion member includes a protrusion rod and a pushing member which includes a cylinder and a pusher.

5. The implant drill according to claim 4, wherein the pusher is a spring which pushes the protrusion rod to be protruded.

6. The implant drill according to claim 4, wherein the pusher is magnets which push the protrusion member to be protruded.

7. The implant drill according to claim 4, wherein the pusher a fluid pressure apparatus including hydraulically operated presser

8. The implant drill according to claim 3, wherein the protrusion member has a shape being wide at both end parts and narrow in a middle part so that the middle part is hinge-coupled at an end of the drill, and the protrusion member with a first end positioned outside the drill and a second end positioned inside the drill is free from the rotation of the drill and the second end of the protrusion member, positioned inside the drill, has a conical shape, and the apex part of the second end is supported inside the drill.

9. The implant drill according to claim 3, wherein the cylinder comprises an opening on the side wall.

10. The implant drill according to claim 9, wherein a marker is made on the head of the protrusion member to see the marker through the opening.

11. The implant drill according to claim 3, wherein the cylinder is divided into two pieces and the pieces are coupled with a coupling.
